(19) United States
(12) Patent Application Publication
(10) Pub. No.: US 2026/0209526 A1
(43) Pub. Date: Jul. 23, 2026

(54) HYDROPHOBIC ANTI-CORROSION COATING AND PREPARATION METHOD THEREFOR

(71) Applicants: China Testing & Certification International Group Co., Ltd., Beijing (CN); China Building Materials Academy, Beijing (CN)

(72) Inventors: Kuilin Lv, Beijing (CN); Huachao Ma, Beijing (CN); Detian Wan, Beijing (CN); Lei Zhang, Beijing (CN); Haiyan Li, Beijing (CN); Dake Cao, Beijing (CN); Yuan Tian, Beijing (CN); Shuai Fu, Beijing (CN)

(21) Appl. No.: 19/449,372

(22) Filed: Jan. 14, 2026

(30) Foreign Application Priority Data
Jan. 17, 2025 (CN) 202510076644.7

(51) Int. Cl. C09D 5/08; C01B 33/18; C08K 3/34; C08K 3/36; C09D 7/40; C09D 7/61; C09D 7/80; C09D 133/04; C23F 11/173

(52) U.S. Cl. CPC C09D 5/084; C01B 33/18; C09D 7/61; C09D 7/67; C09D 7/80; C09D 133/04; C23F 11/173; C01P 2002/82; C01P 2004/03; C01P 2004/04; C01P 2004/64; C08K 3/346; C08K 3/36; C08K 2201/011

(57) ABSTRACT

A preparation method for a hydrophobic anti-corrosion coating includes the steps of: step 1: preparing nano-silica; step 2: adding kaolin powder, acrylic resin (AR) and nano-silica into ethyl acetate, and performing magnetic stirring on the mixture at room temperature after ultrasonic dispersion to obtain a pre-cured mixed liquid; and a mass ratio of the kaolin powder, the acrylic acid resin and the nano-silica being 1:0.66:0.05; and step 3: coating the pre-cured mixed liquid droplets on a substrate, followed by solidifying to obtain a hydrophobic anti-corrosion coating. In the present disclosure, a film is prepared by using kaolin and AR. Kaolin with specific particle sizes can reduce pores of the film as much as possible. The added modified nano-silica is further used to fill the pores, and the prepared coating is endowed with better hydrophobic and anti-corrosion effects.

### CROSS-REFERENCE TO RELATED APPLICATION

This application claims priority of Chinese Patent Application No. 202510076644.7, filed on Jan. 17, 2025, the entire contents of which are incorporated herein by reference.

### TECHNICAL FIELD

The present disclosure relates to the technical field of anti-corrosion coating preparation, particularly to a hydrophobic anti-corrosion coating and a preparation method therefor.

### BACKGROUND

The adverse ecological and economic effects of metal corrosion have driven the research to develop anti-corrosion coatings, and engineered superhydrophobic nanostructured coatings are a promising application technology for self-cleaning and anti-corrosion. The working principle of hydrophobic anti-corrosion coating is to isolate the metal substrate from liquid corrosive media such as water and extend the propagation path of liquid corrosive media. However, superhydrophilic surfaces in air are generally superaerophobic. In contrast, superhydrophobic surfaces in air are superaerophilic. Therefore, during operation, hydrophobic anti-corrosion coatings exhibit higher aerophilicity compared to conventional coatings, enabling another corrosive medium (O₂) to easily come into contact with metal substrates, which may in turn accelerate the corrosion process. Therefore, it is very necessary to explore the scientific issue of the relationship between the hydrophobicity of the coating surface and the anti-corrosion ability.

Commonly used anti-corrosion coatings mainly include epoxy resin coatings, polyurethane resin coatings, and acrylic resin (AR) coatings. AR anti-corrosion coatings have good weather resistance, gloss and color retention, high glossiness and decorative properties, as well as good temperature resistance (able to withstand 160° C.), fast drying speed, ability to cure normally even at 0° C., high one-time film thickness, and fewer construction passes. In the related art, there are related patents to prepare superhydrophobic AR. For example, CN102417773A provides a superhydrophobic AR coating, including nanoparticles, AR, mixed solvent and heptafluorotrimethoxy ethoxysilane, and a contact angle of water droplets on the surface of the prepared coating is between 150° to 160°. CN111269628A provides a superhydrophobic antifouling flashover coating with live-line construction and a preparation method therefor. The coating includes the following raw materials: modified nano-silica, modified low surface energy resin, dispersant, defoamer, leveling agent, and live-line applicable solvent. The modified nano-silica is prepared from the following raw materials in parts by weight: trifluoropropylmethylcyclotrisiloxane, 1H, 1H,2H,2H-perfluorooctyltrichlorosilane, 1H, 1H,2H,2H-perfluorodecyltriethoxysilane, trifluoromethyltrimethylsilane, nano-silica powder, and live-line applicable solvent. The coating formed by the coating prepared by this disclosure has super hydrophobic, super self-cleaning and antifouling capabilities. However, neither of the above two patents discloses whether it has anti-corrosion properties.

CN118995011A provides a high-temperature resistant superhydrophobic long-acting anti-corrosion coating and a preparation method therefor. Specifically, γ-methacryloxypropyltrimethoxysilane is used for surface modification of nanoparticles to obtain modified nanoparticles; vinyltrimethoxysilane is used for surface modification of nano-silica to obtain superhydrophobic silica; the modified nanoparticles, superhydrophobic silica are polymerized with methacrylic acid, and grafted onto phenolic epoxy resin through ring-opening reaction to obtain modified epoxy vinyl resin; the modified epoxy vinyl resin and curing agent are mixed uniformly, sprayed onto the surface of metal substrate, and cured to obtain the high-temperature resistant superhydrophobic long-acting anti-corrosion coating. This disclosure not only improves the cross-linking density, heat resistance, barrier property and toughness of epoxy vinyl resin, but also enhances the hydrophobicity of the coating, endowing the coating with long-acting anti-corrosion performance. However, the film-forming substance of the anti-corrosion coating is epoxy resin, and the anti-corrosion properties of AR as a film-forming substance has not been disclosed.

CN116410638A uses dodecafluoroheptylpropyltrimethoxysilane as a catalyst to promote the condensation reaction between silanol groups produced by the hydrolysis of methacryloxypropyltrimethoxysilane and hydroxyl groups on the surface of nano-silica, followed by a further fluorination reaction with perfluorooctylethyltrichlorosilane. A large number of hydrophobic fluorinated groups and long alkyl chains are introduced onto the surface of nano-silica to prepare modified silica filler. The modified fluorinated silica filler and talcum powder with different mesh sizes are added into AR to prepare a compression-resistant and wear-resistant hydrophobic anti-corrosion coating. However, the anti-corrosion performance of the coating needs to be further improved.

### SUMMARY

To solve the problems existing in the related art, the present disclosure provides a hydrophobic anti-corrosion coating and a preparation method therefor. In the present disclosure, kaolin and acrylic acid resin are selected to prepare a film, the kaolin with specific particle size can reduce the pores of the film as much as possible, the pores are further filled by adding modified nano-silica, and the prepared coating has better anti-corrosion effect.

To solve the above technical problems, the present disclosure provides the following technical solutions.

In one aspect, the present disclosure provides a preparation method for a hydrophobic anti-corrosion coating, including the steps of:
step 1: preparing nano-silica;
step 2: adding kaolin powder, AR and nano-silica into ethyl acetate, and performing magnetic stirring on the mixture at room temperature after ultrasonic dispersion to obtain a pre-cured mixed liquid, and a mass ratio of the kaolin powder, the acrylic acid resin and the nano-silica being 1:0.66:0.05; and
step 3: coating the pre-cured mixed liquid droplets on a substrate, followed by solidifying to obtain a hydrophobic anti-corrosion coating.

Further, in step 2, a particle size of the kaolin powder is 1-10 μm. Preferably, the kaolin powder is a mixture of powders with particle sizes of 1-4 μm and 5-8 μm at a mass ratio of 1:2.5.

Preferably, a molecular weight of the acrylic acid resin is 10000-50000. A volume-to-mass ratio of ethyl acetate to AR is 5 mL:1 g.

Further, in step 2, ultrasonic dispersion is performed for 30-60 minutes, and magnetic stirring is performed for 1-4 hours.

In step 2, the substrate is a Q235 steel electrode sheet or a glass sheet; and a drop-coating amount of the pre-cured mixture is 0.5-2 mL/cm². The curing is performed at room temperature for 12-24 hours.

Preferably, a preparation method for the nano-silica includes the steps of: dispersing absolute ethanol solution and ammonia water at a volume ratio of 1:1 in a beaker, and placing the above solution under magnetic stirring for 0.5 hours; adding 2 mL of tetraethyl orthosilicate (TEOS) dropwise to a continuously stirred mixed solution and stirring continuously for 4 hours; and centrifuging at 5000 r/min for 30 minutes, removing a supernatant, performing suction filtration on a solid, and washing the solid with ethanol 2-5 times to obtain the nano-silica.

Alternatively, preferably, the preparation method for the nano-silica includes the steps of:
(1) mixing absolute ethanol solution and ammonia water, followed by stirring evenly to obtain a mixed solution;
a volume ratio of the ethanol solution to ammonia water being 1:1, a volume fraction of ethanol in the ethanol solution being 90%; and a mass fraction of NH₃·H₂O in the ammonia water being 25% to 28%;
(2) adding a silane modifier to the above mixed solution, followed by stirring uniformly;
the silane modifier being a mixture of dimethyldiethoxysilane, vinyltrimethoxysilane and γ-aminopropyltriethoxysilane at a mass ratio of 1:1.5:2; and a mass-to-volume ratio of the silane modifier to the mixed solution in step (1) being 0.5-0.8 g: 100 mL;
(3) adding TEOS dropwise to the mixed solution of step (2) under stirring conditions, followed by stirring continuously for 2-6 hours, and a volume ratio of TEOS to the mixed solution in step (1) being 1:50-100;
(4) adding a fluorine-containing modifier, followed by stirring uniformly, the fluorine-containing modifier being a mixture of hexafluorobutyl methacrylate and 1H, 1H,2H,2H-perfluorodecyltriethoxysilane at a mass ratio of 1:0.8; and a mass ratio of the fluorine-containing modifier to the silane modifier being 1:0.4-0.6; and
(5) performing centrifugal separation to obtain a solid product, washing the solid product with absolute ethanol 2-5 times, followed by drying, and grinding and sieving the solid to obtain the nano-silica.

In another aspect, the present disclosure also provides a hydrophobic anti-corrosion coating prepared by the above method.

Compared with the related art, the present disclosure has the following beneficial effects.

In the present disclosure, a film is prepared by using kaolin and AR. Kaolin with specific particle sizes can reduce the pores of the film as much as possible. The added modified nano-silica is further used to fill the pores, and the prepared coating is endowed with better hydrophobic and anti-corrosion effects. In the present disclosure, after surface modification, nano-silica achieves good dispersion in AR with a specific molecular weight through synergy with kaolin. The synergistic effect of kaolin, AR and modified nano-silica is exerted to effectively fill the gaps on the coating surface, thereby blocking more corrosive media outside the coating surface. These characteristics are enabled to improve the barrier property and anti-corrosion performance of the coating.

### BRIEF DESCRIPTION OF THE DRAWINGS

FIG. 1A is an infrared spectroscopy (IR) spectrum of purchased nano-silica nanoparticles;

FIG. 1B is an IR spectrum of nano-silica prepared in Example 1 of the present disclosure;

FIG. 2A is a scanning electron microscopy (SEM) image of the nano-silica prepared in Example 1 of the present disclosure;

FIG. 2B is an SEM image of the nano-silica prepared in Example 1 of the present disclosure;

FIG. 2C is a transmission electron microscopy (TEM) image of the nano-silica prepared in Example 1 of the present disclosure;

FIG. 2D is a TEM image of the nano-silica prepared in Example 1 of the present disclosure;

FIG. 3A is an SEM image of a coating prepared in Comparative Example 1, with an inset being a water contact angle image of the coating;

FIG. 3B is an SEM image of a coating prepared in Example 1, with an inset being a water contact angle image of the coating;

FIG. 3C is an SEM image of a coating prepared in Comparative Example 2, with an inset being a water contact angle image of the coating;

FIG. 3D is an SEM image of a coating prepared in Comparative Example 3, with an inset being a water contact angle image of the coating;

FIG. 3E is an SEM image of a coating prepared in Comparative Example 4, with an inset being a water contact angle image of the coating;

FIG. 3F is an SEM image of a coating prepared in Comparative Example 5, with an inset being a water contact angle image of the coating;

FIG. 3G is an SEM image of a coating prepared in Comparative Example 6, with an inset being a water contact angle image of the coating;

FIG. 4A shows impedance results of hydrophobic coatings from Comparative Example 1, Example 1, Comparative Example 2 and Comparative Example 3 after immersion in a 3.5 wt % NaCl solution for 1 day;

FIG. 4B shows impedance results of hydrophobic coatings from Comparative Example 1, Example 1, Comparative Example 2 and Comparative Example 3 after immersion in a 3.5 wt % NaCl solution for 3 days;

FIG. 4C shows impedance results of hydrophobic coatings from Comparative Example 1, Example 1, Comparative Example 2 and Comparative Example 3 after immersion in a 3.5 wt % NaCl solution for 7 days;

FIG. 5A shows impedance results of hydrophobic coatings from Comparative Example 4, Comparative Example 5 and Comparative Example 6 after immersion in a 3.5 wt % NaCl solution for 1 day;

FIG. 5B shows impedance results of hydrophobic coatings from Comparative Example 4, Comparative Example 5 and Comparative Example 6 after immersion in a 3.5 wt % NaCl solution for 3 days;

FIG. 5C shows impedance results of hydrophobic coatings from Comparative Example 4, Comparative Example 5 and Comparative Example 6 after immersion in a 3.5 wt % NaCl solution for 7 days;

FIG. 6A shows Bode results of hydrophobic coatings from Comparative Example 1, Example 1, Comparative Example 2 and Comparative Example 3 after immersion in a 3.5 wt % NaCl solution for 1 day;

FIG. 6B shows Bode results of hydrophobic coatings from Comparative Example 1, Example 1, Comparative Example 2 and Comparative Example 3 after immersion in a 3.5 wt % NaCl solution for 3 days;

FIG. 6C shows Bode results of hydrophobic coatings from Comparative Example 1, Example 1, Comparative Example 2 and Comparative Example 3 after immersion in a 3.5 wt % NaCl solution for 7 days;

FIG. 7A shows Bode results of hydrophobic coatings from Comparative Example 4, Comparative Example 5 and Comparative Example 6 after immersion in a 3.5 wt % NaCl solution for 1 day;

FIG. 7B shows Bode results of hydrophobic coatings from Comparative Example 4, Comparative Example 5 and Comparative Example 6 after immersion in a 3.5 wt % NaCl solution for 3 days; and

FIG. 7C shows Bode results of hydrophobic coatings from Comparative Example 4, Comparative Example 5 and Comparative Example 6 after immersion in a 3.5 wt % NaCl solution for 7 days.

### DETAILED DESCRIPTION

For clearer technical problems, technical solutions and advantages of the present disclosure, the following will be described in detail with reference to accompanying drawings and specific examples.

The materials and reagents used in the present disclosure are commercially available unless otherwise specified. A volume fraction of ethanol in ethanol solution is 90%, and a mass fraction of NH₃·H₂O in ammonia water is 28%.

The present disclosure provides a hydrophobic anti-corrosion coating and a preparation method therefor, and the specific examples are as follows.

### Example 1

The present disclosure provides a preparation method for a hydrophobic anti-corrosion coating, including the following steps.

In step 1: nano-silica was prepared:

Absolute ethanol (50 mL) and ammonia solution (50 mL) were dispersed in a 250 mL beaker. The above mixed solution was placed under magnetic stirring and stirred for 0.5 hours until no delamination occurred in the solution. 2 mL of TEOS was added dropwise to the continuously stirred mixed solution; and floccules appeared in the solution, and stirring was continued for 4 hours until no more silica spheres were generated. The mixture was centrifuged at 5000 r/min for 30 minutes using a high-speed centrifuge; the supernatant was removed, and the solid was subjected to suction filtration (the filter membrane was a polyvinyl chloride (PVC) membrane with a pore size of 0.22 μm) to remove residual absolute ethanol and ammonia solution. The solid was washed twice with ethanol, and self-prepared silica nanoparticles were obtained.

In step 2:1.0 g of kaolin powder, 0.66 g of AR (SGR-7120 with a molecular weight of 13000, supplied by Guangzhou Changhao Trading Co., Ltd., formerly Guangzhou Xianghao Chemical Co., Ltd.) and 0.05 g of nano-silica were added to ethyl acetate. The mixture was ultrasonically dispersed for 30 minutes and magnetically stirred for 4 hours, followed by further magnetic stirring at room temperature, and a pre-cured mixture was obtained. The kaolin powder was a mixture of particles with sizes of 1-4 μm and 5-8 μm at a mass ratio of 1:2.5.

In step 3: the pre-cured mixed liquid was drop-coated onto the substrate, Q235 steel electrode sheet, with a drop-coating amount of 2 mL/cm². The coating was cured at room temperature for 24 hours, and a hydrophobic anti-corrosion coating was obtained, which was designated as CK_{1.0}SO_{0.05}AR (where x represents kaolin content and y represents modified silica content).

To further illustrate the beneficial effects of the present disclosure, the following Comparative Examples are constructed.

### Comparative Example 1

In this comparative example, a dosage of nano-silica was set at 0 g. All other conditions were kept the same as those in Example 1, and the obtained coating was designated as CK_{1.0}SO₀AR.

### Comparative Example 2

In this comparative example, a dosage of nano-silica was set at 0.10 g. All other conditions were kept the same as those in Example 1, and the obtained coating was designated as CK_{1.0}SO_{0.10}AR.

### Comparative Example 3

In this comparative example, a dosage of kaolin powder was set at 0.17 g. All other conditions were kept the same as those in Example 1, and the obtained coating was designated as CK_{1.0}SO_{0.17}AR.

### Comparative Example 4

In this comparative example, a dosage of kaolin powder was set at 0.20 g. All other conditions were kept the same as those in Example 1, and the obtained coating was designated as CK_{1.0}SO_{0.20}AR.

### Comparative Example 5

In this comparative example, a dosage of kaolin powder was set at 0.25 g. All other conditions were kept the same as those in Example 1, and the obtained coating was designated as CK_{1.0}SO_{0.25}AR.

### Comparative Example 6

In this comparative example, a dosage of kaolin powder was set at 0.30 g. All other conditions were kept the same as those in Example 1, and the obtained coating was designated as CK_{1.0}SO_{0.30}AR.

The coatings obtained in the above Examples and Comparative Examples were subjected to performance tests, and the results were as follows.

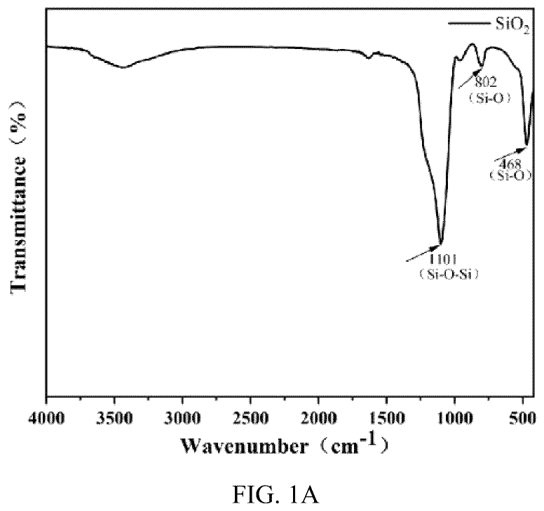

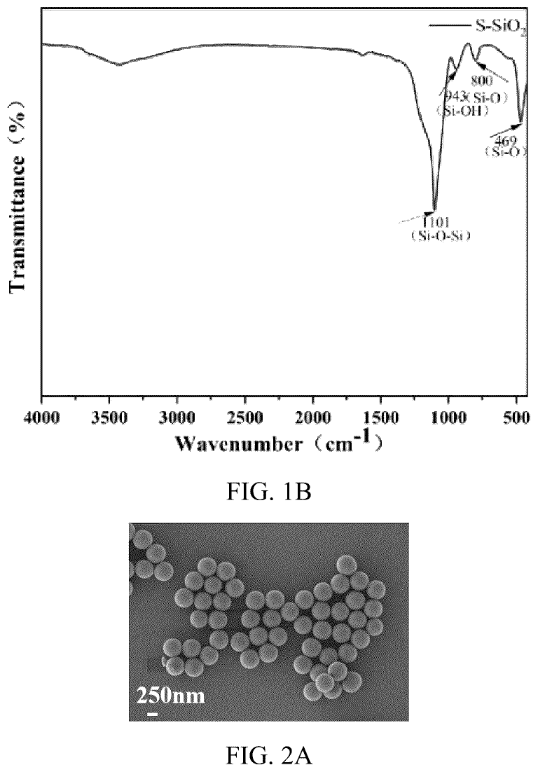

To observe the difference between self-prepared silica nanoparticles and purchased silica nanoparticles, and whether self-prepared silica nanoparticles were successfully added to the coatings, infrared testing was used to characterize the particles and superhydrophobic coatings. FIGS. 1A and 1B show infrared spectroscopy (IR) spectrums of purchased silica nanoparticles and self-prepared silica nanoparticles. It can be clearly observed from the figures that absorption peaks of the Si—O bond at 468 cm⁻¹ and 800 cm⁻¹, as well as an absorption peak of the Si—O—Si bond at 1101 cm⁻¹, in the self-prepared silica nanoparticles are weaker than those in the purchased silica nanoparticles. However, an absorption peak of the Si—OH bond at 943 cm⁻¹, which is absent in the purchased silica nanoparticles, appears in the self-prepared ones. This confirms that the hydroxyl groups on the surface of the self-prepared silica nanoparticles are significantly increased, thus facilitating substitution reactions and modification into hydrophobic particles.

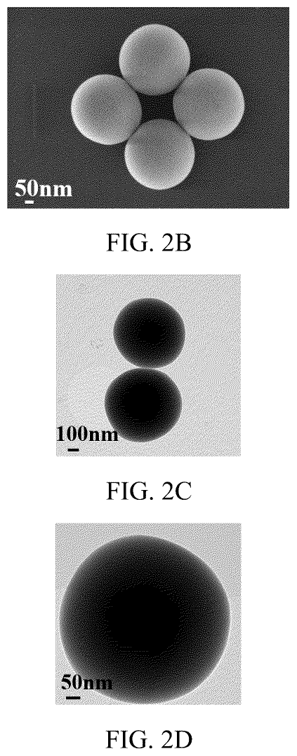

TEOS molecules are hydrolyzed under the catalysis of ammonia hydroxide, TEOS groups are converted to form Si—OH groups. Polycondensation reactions are performed between adjacent Si—OH groups, thus inducing the self-assembly of silica nanoparticles covered with Si—OH groups. FIGS. 2A-2D show SEM and TEM images of the as-prepared silica nanoparticles. By observing the morphology and particle size of the silica nanoparticles, it is found that the as-prepared silica nanoparticles exhibit uniform distribution, with particle sizes ranging from approximately 450±50 nm and an average particle size of 470 nm.

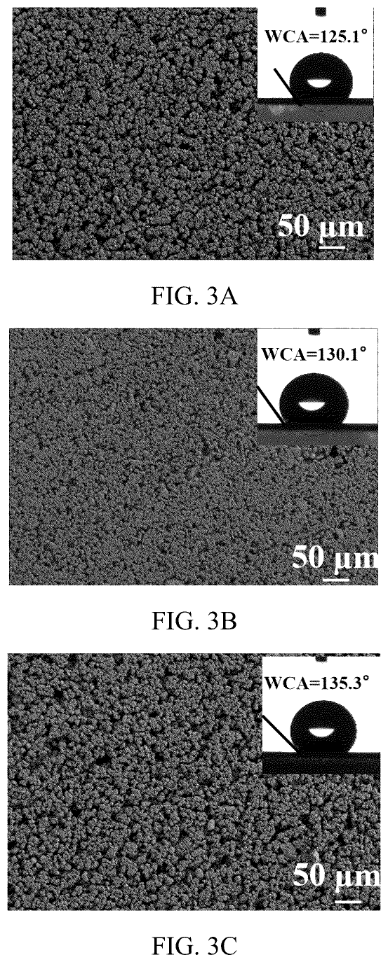

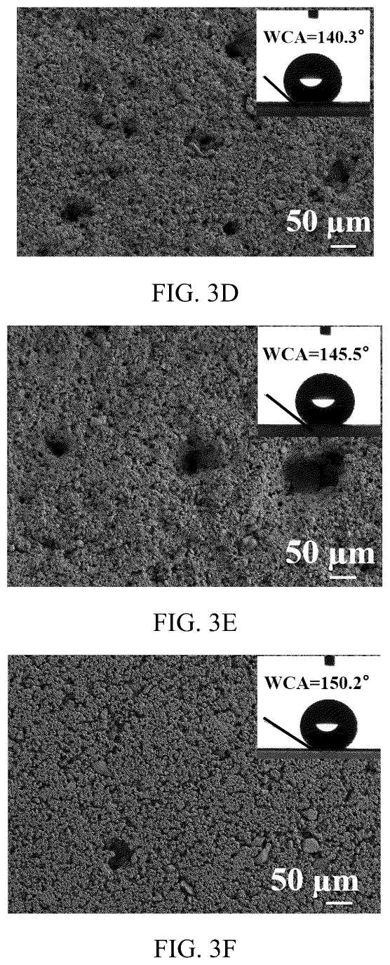

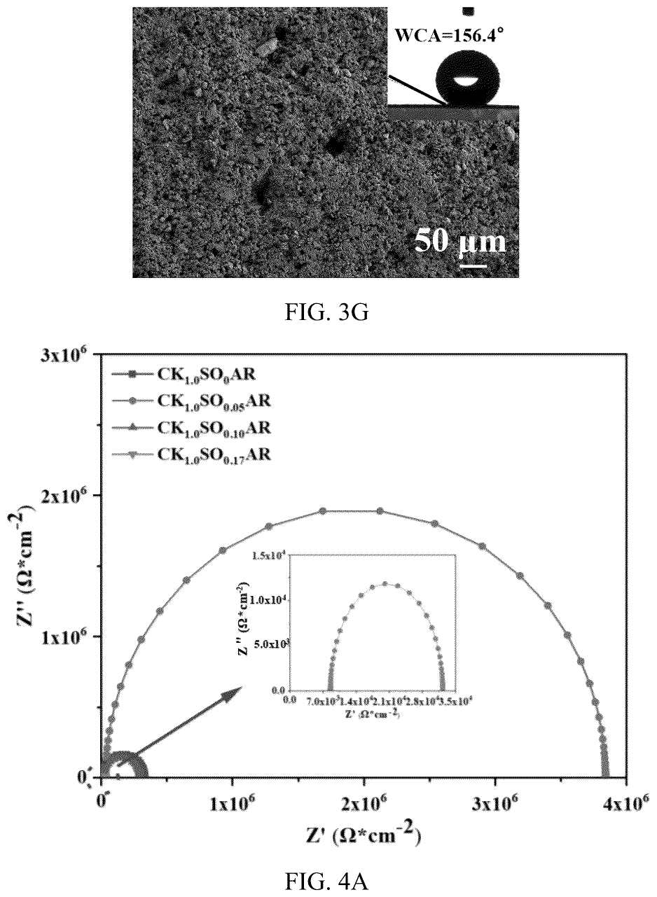

To investigate the surface characteristics and wettability of different hydrophobic coatings, SEM and water contact angle tests were performed for coating characterization. The results are shown in FIGS. 3A-3G. The dosages of modified silica nanoparticles in samples A, B, C, D, E, F and G are 0 g, 0.05 g, 0.10 g, 0.17 g, 0.20 g, 0.25 g and 0.30 g. As can be seen from FIGS. 3A-3G, samples A, B, C, D, E, F and G correspond to SEM images with water contact angles of 125°, 130°, 135°, 140°, 145°, 150° and 156°. As observed from FIGS. 3A and 3B, when the water contact angle increases from 125° to 135°, the increase in coating particles leads to the filling of pores in the coating, and it is inferred that the ability of the coating to block water molecules and oxygen molecules in the air is enhanced accordingly. As observed from FIGS. 3C and 3D, when the water contact angle of the coating exceeds 135°, a gradual increase in coating particles leads to the accumulation of particles, and stacked structures are formed. The probability of contact between the substrate and water as well as oxygen molecules in the air is increased. When the contact angle reaches 140°, the largest number of macropores are formed by the stacked structures, the probability of contact between the substrate and water as well as oxygen molecules in the air is maximized, and the anti-corrosion ability of the coating is expected to be the poorest. As observed from FIGS. 3E, 3F and 3G, when the water contact angle increases from 145° to 156°, the number of pores formed by the stacked structures remains almost unchanged with the increase in the water contact angle of the coating, while the pore size shows a slight decreasing trend. It is inferred that the anti-corrosion ability of the coatings remains almost the same and shows a slight upward trend. To verify this result, an electrochemical workstation is adopted to represent the anti-corrosion ability of each coating, thereby representing the variation trend of the contact probability between the substrate and water as well as oxygen molecules in the air.

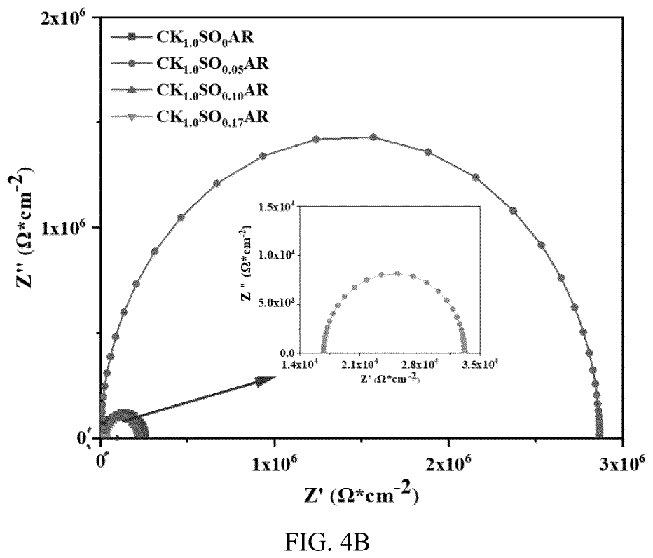

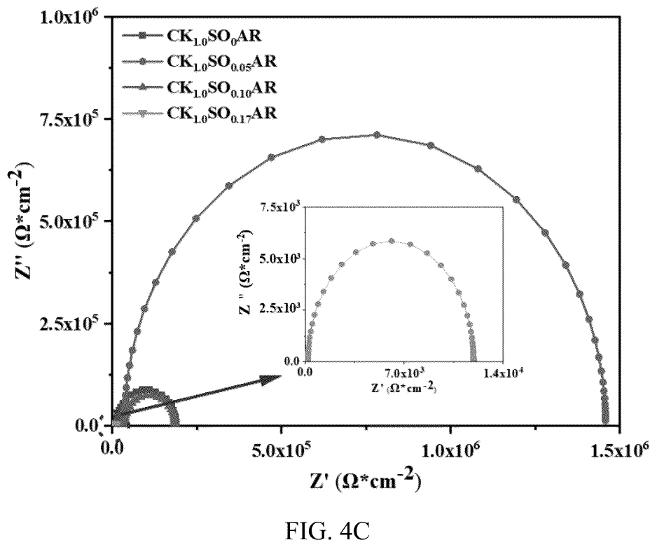

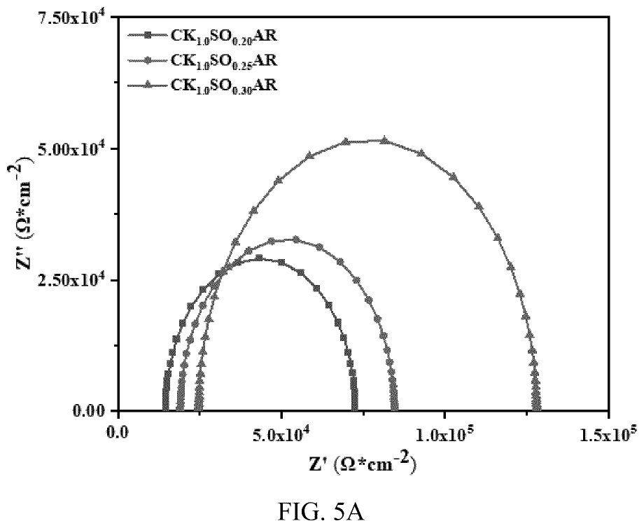

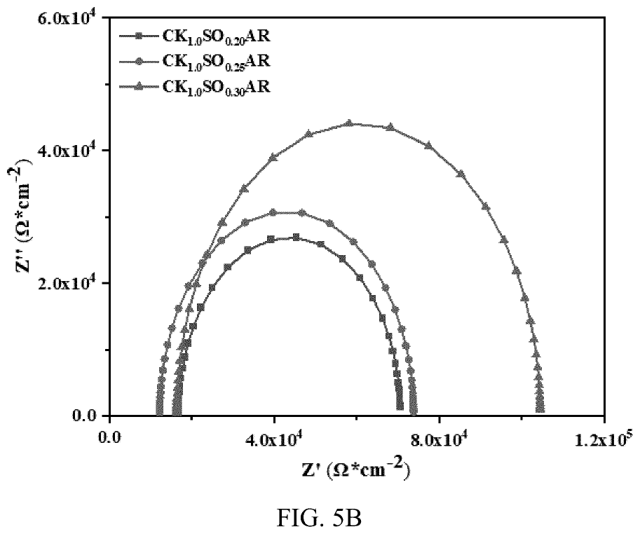

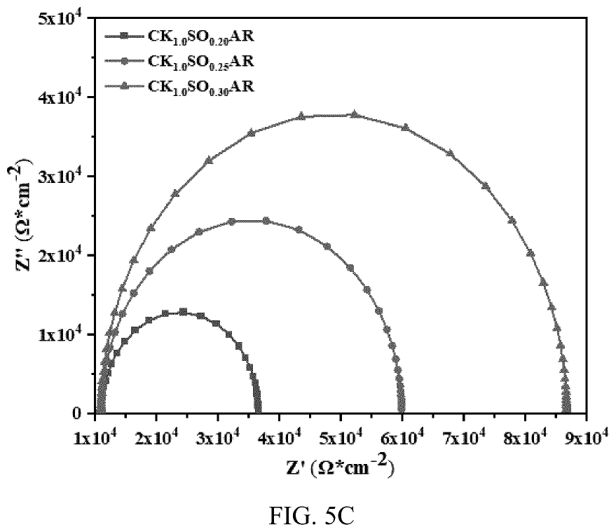

To determine the anti-corrosion ability of different hydrophobic coatings, electrochemical tests are performed on Q235 steel electrode sheets coated with different hydrophobic coatings, and the impedance test results are presented in FIGS. 4A-5C.

FIG. 4A shows impedance results of hydrophobic coatings from Comparative Example 1, Example 1, Comparative Example 2 and Comparative Example 3 after immersion in a 3.5 wt % NaCl solution for 1 day; FIG. 4B shows impedance results of hydrophobic coatings from Comparative Example 1, Example 1, Comparative Example 2 and Comparative Example 3 after immersion in a 3.5 wt % NaCl solution for 3 days; and FIG. 4C shows impedance results of hydrophobic coatings from Comparative Example 1, Example 1, Comparative Example 2 and Comparative Example 3 after immersion in a 3.5 wt % NaCl solution for 7 days. The specific data are shown in Table 1.

TABLE 1

| | | Rs | | Rp |
|---|---|---|---|---|
| | | (Solution | C | (Polarization |
| Time | | resistance) | (Capacitance) | resistance) |
| (days) | Sample No. | (Ω · cm²) | (Ω⁻¹ · cm⁻² · sn) | (Ω · cm²) |
| 1 | CK_{1.0}SO₀AR | 2.33 × 10³ | 2.58 × 10⁻¹⁰ | 3.30 × 10⁵ |
| | CK_{1.0}SO_{0.05}AR | 3.37 × 10⁴ | 3.79 × 10⁻¹¹ | 3.80 × 10⁶ |
| | CK_{1.0}SO_{0.10}AR | 9.89 × 10³ | 2.17 × 10⁻¹⁰ | 2.88 × 10⁵ |
| | CK_{1.0}SO_{0.17}AR | 8.56 × 10³ | 6.91 × 10⁻⁶ | 2.36 × 10⁴ |
| 3 | CK_{1.0}SO₀AR | 1.63 × 10⁴ | 4.83 × 10⁻⁸ | 2.41 × 10⁵ |
| | CK_{1.0}SO_{0.05}AR | 3.36 × 10³ | 8.02 × 10⁻¹¹ | 2.86 × 10⁶ |
| | CK_{1.0}SO_{0.10}AR | 2.26 × 10⁴ | 2.33 × 10⁻⁷ | 1.98 × 10⁵ |
| | CK_{1.0}SO_{0.17}AR | 1.67 × 10⁴ | 7.35 × 10⁻⁶ | 1.63 × 10⁴ |
| 7 | CK_{1.0}SO₀AR | 1.24 × 10⁴ | 5.14 × 10⁻⁸ | 1.76 × 10⁵ |
| | CK_{1.0}SO_{0.05}AR | 3.50 × 10⁴ | 1.06 × 10⁻⁸ | 1.42 × 10⁶ |
| | CK_{1.0}SO_{0.10}AR | 3.48 × 10⁴ | 1.53 × 10⁻⁸ | 1.51 × 10⁵ |
| | CK_{1.0}SO_{0.17}AR | 1.78 × 10² | 2.13 × 10⁻⁶ | 1.17 × 10⁴ |

The water contact angles of the hydrophobic coatings of Comparative Example 1, Example 1, Comparative Example 2 and Comparative Example 3 ranged from 125° to 140°. As shown in Table 1, after immersion in a 3.5 wt % NaCl solution for 1 day, the CK_{1.0}SO_{0.05}AR coating exhibited the impedance arc with the largest radius, which was approximately 3.80×10⁶ Ω·cm², almost one to two orders of magnitude larger than those of the other hydrophobic coatings. The impedance radius of the CK_{1.0}SO₀AR coating was 3.30×10⁵ Ω·cm², which was nearly the same as that of the CK_{1.0}SO_{0.10}AR coating (2.88×10⁵ Ω·cm²), and both were more than one order of magnitude larger than that of the CK_{1.0}SO_{0.17}AR coating (2.36×10⁴ Ω·cm²). This indicated that for the coatings with water contact angles ranging from 125° to 140°, after immersion in a 3.5 wt % NaCl solution for 1 day, the anti-corrosion ability showed a trend of first increasing and decreasing, and the coating with a water contact angle of 130° had the optimal anti-corrosion ability. After immersion in a 3.5 wt % NaCl solution for 3 days, the CK_{1.0}SO_{0.05}AR coating still showed the impedance arc with the largest radius, which was 2.86×10⁶ Ω·cm². The impedance radius of the CK_{1.0}SO₀AR coating was 2.41×10⁵ Ω·cm², which was larger than that of the CK_{1.0}SO_{0.10}AR coating (1.98×10⁵ Ω·cm²), and both were larger than that of the CK_{1.0}SO_{0.17}AR coating (1.63×10⁴ Ω·cm²). This proved that for the coatings with water contact angles ranging from 125° to 140°, after immersion in a 3.5 wt % NaCl solution for 3 days, the variation trend of the anti-corrosion ability was consistent with that after immersion for 1 day. After immersion in a 3.5 wt % NaCl solution for 7 days, the impedance radius of the CK_{1.0}SO_{0.05}AR coating was 1.42×10⁶ Ω·cm², which was one to two orders of magnitude higher than those of the other coatings. The impedance radius of the CK_{1.0}SO₀AR coating was 1.76×10⁵ Ω·cm², which was larger than that of the CK_{1.0}SO_{0.10}AR coating (1.51×10⁵ Ω·cm²), and both were more than one order of magnitude higher than that of the CK_{1.0}SO_{0.17}AR coating (1.17×10⁴ Ω2·cm²). This proved that for the coatings with water contact angles ranging from 125° to 140°, after immersion in a 3.5 wt % NaCl solution for 7 days, the variation trend of the anti-corrosion ability was consistent with those after immersion for 1 day and 3 days.

FIG. 5A shows impedance results of the hydrophobic coatings from Comparative Example 4 (sample E), Comparative Example 5 (sample F) and Comparative Example 6 (sample G) after immersion in a 3.5 wt % NaCl solution for 1 day; FIG. 5B shows impedance results of the same hydrophobic coatings after immersion for 3 days; and FIG. 5C shows impedance results of the same hydrophobic coatings after immersion for 7 days. The specific data are shown in Table 2.

TABLE 2

| Time | | Rs | C | Rp |
|---|---|---|---|---|
| (days) | Sample No. | (Ω · cm²) | (Ω⁻¹ · cm⁻² · sn) | (Ω · cm²) |
| 1 | CK_{1.0}SO_{0.20}AR | 1.45 × 10⁴ | 1.09 × 10⁻⁶ | 5.81 × 10⁴ |
| | CK_{1.0}SO_{0.25}AR | 1.89 × 10⁴ | 7.07 × 10⁻⁷ | 6.54 × 10⁴ |
| | CK_{1.0}SO_{0.30}AR | 2.46 × 10⁴ | 1.10 × 10⁻⁷ | 1.03 × 10⁵ |
| 3 | CK_{1.0}SO_{0.20}AR | 1.67 × 10⁴ | 6.97 × 10⁻⁷ | 5.38 × 10⁴ |
| | CK_{1.0}SO_{0.25}AR | 1.21 × 10⁴ | 2.28 × 10⁻⁷ | 6.16 × 10⁴ |
| | CK_{1.0}SO_{0.30}AR | 1.63 × 10⁴ | 1.90 × 10⁻⁷ | 8.81 × 10⁴ |
| 7 | CK_{1.0}SO_{0.20}AR | 1.10 × 10⁴ | 4.72 × 10⁻⁶ | 2.55 × 10⁴ |
| | CK_{1.0}SO_{0.25}AR | 1.09 × 10⁴ | 3.71 × 10⁻⁶ | 4.89 × 10⁴ |
| | CK_{1.0}SO_{0.30}AR | 1.10 × 10⁴ | 1.52 × 10⁻⁷ | 7.57 × 10⁴ |

For coatings with water contact angles ranging from 145° to 156°, after immersion in a 3.5 wt % NaCl solution for 1 day, the CK_{1.0}SO_{0.30}AR coating exhibited the impedance arc with the largest radius, which was 1.03×10⁵ Ω·cm². This value was higher than the impedance radius of the CK_{1.0}SO_{0.25}AR coating (6.54×10⁴ Ω·cm²), and both were higher than the impedance radius of the CK_{1.0}SO_{0.20}AR coating (5.81×10⁴ Ω·cm²). This indicated that for coatings with water contact angles ranging from 145° to 156°, after immersion in a 3.5 wt % NaCl solution for 1 day, the anti-corrosion ability showed an upward trend, but was weaker than that of the coating with a water contact angle of 130°. After immersion in a 3.5 wt % NaCl solution for 3 days, the CK_{1.0}SO_{0.30}AR coating still exhibited the impedance arc with the largest radius, which was 8.81×10⁴ Ω·cm². This value was higher than the impedance radius of the CK_{1.0}SO_{0.25}AR coating (6.16×10⁴ Ω·cm²), and both were higher than the impedance radius of the CK_{1.0}SO_{0.20}AR coating (5.38×10⁴ Ω·cm²). This was consistent with the corrosion variation trend observed after 1 day of immersion. After immersion in a 3.5 wt % NaCl solution for 7 days, the CK_{1.0}SO_{0.30}AR coating still exhibited the impedance arc with the largest radius, which was 7.57×10⁴ Ω·cm². This value was higher than the impedance radius of the CK_{1.0}SO_{0.25}AR coating (4.89×10⁴ Ω·cm²), and both were higher than the impedance radius of the CK_{1.0}SO_{0.20}AR coating (2.55×10⁴ Ω·cm²). This was consistent with the variation trends observed after 1 day and 3 days of immersion.

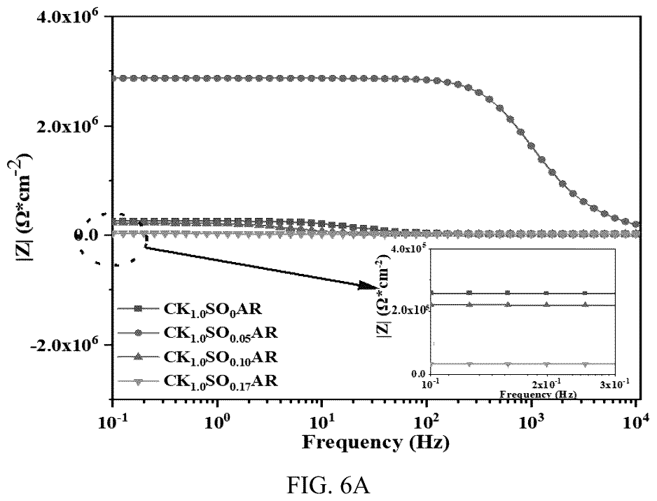

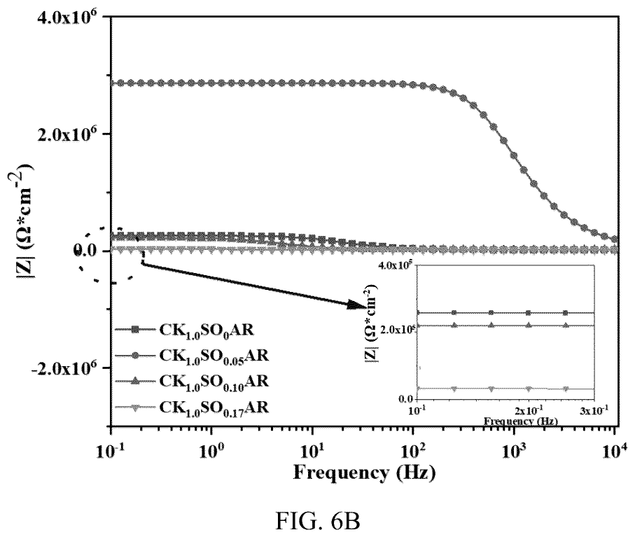

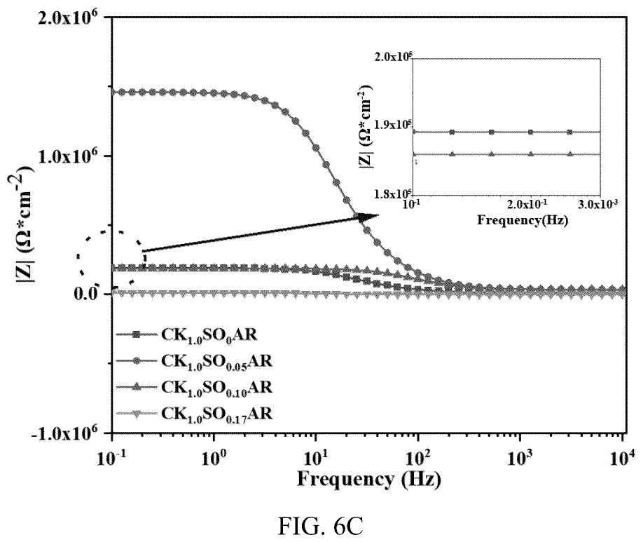

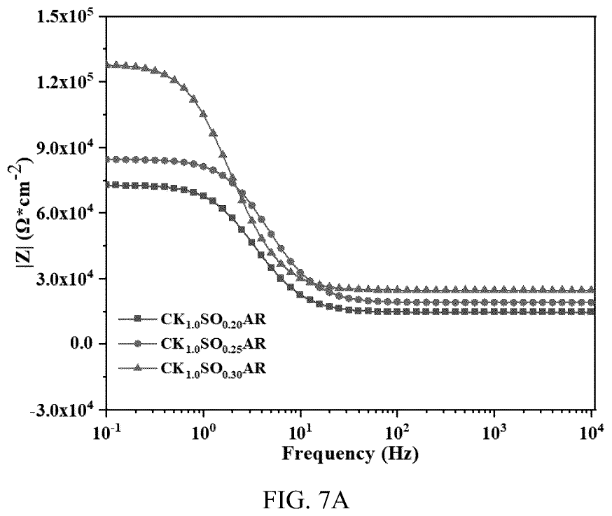

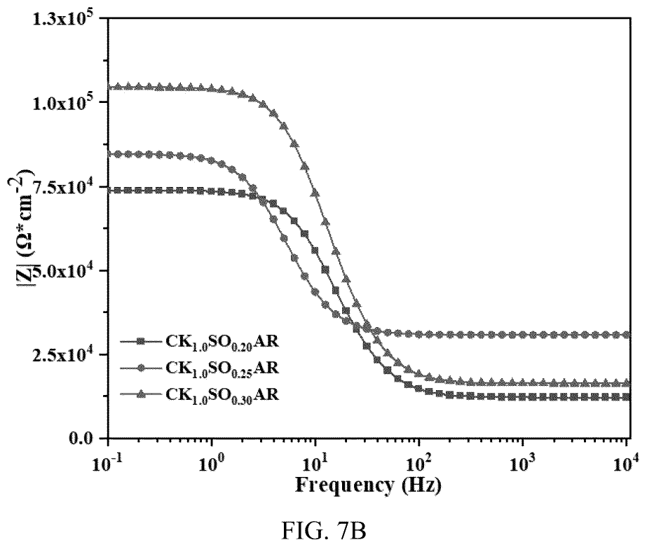

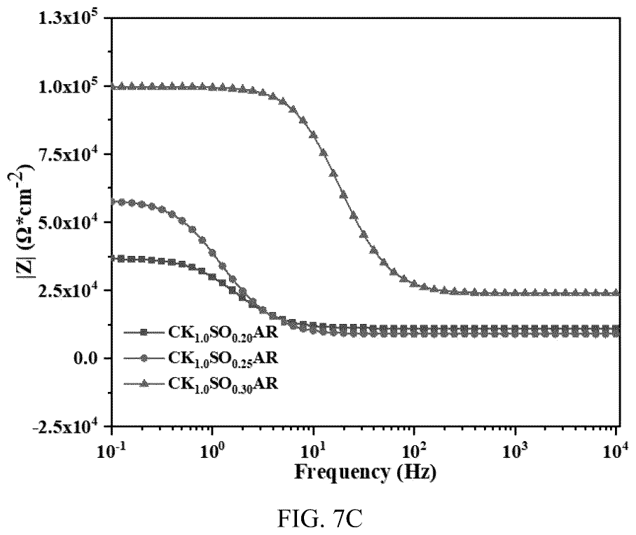

For the Bode test of different hydrophobic coatings, the results are shown in FIGS. 6A-7C. FIG. 6A shows Bode results of hydrophobic coatings from Comparative Example 1, Example 1, Comparative Example 2 and Comparative Example 3 after immersion in a 3.5 wt % NaCl solution for 1 day; FIG. 6B shows Bode results of hydrophobic coatings from Comparative Example 1, Example 1, Comparative Example 2 and Comparative Example 3 after immersion in a 3.5 wt % NaCl solution for 3 days; and FIG. 6C shows Bode results of hydrophobic coatings from Comparative Example 1, Example 1, Comparative Example 2 and Comparative Example 3 after immersion in a 3.5 wt % NaCl solution for 7 days.

For coatings with water contact angles ranging from 125° to 140°, after immersion in a 3.5 wt % NaCl solution for 1 day, the CK_{1.0}SO_{0.05}AR coating exhibited the maximum Bode modulus at f=0.1 Hz, which was approximately 3.75×10⁶ Ω·cm², nearly one to two orders of magnitude higher than those of other hydrophobic coatings. The modulus value of the CK_{1.0}SO₀AR coating was 3.20×10⁵ Ω·cm², which was higher than that of the CK_{1.0}SO_{0.10}AR coating (2.70×10⁵ Ω·cm²), and both were higher than the modulus value of the CK_{1.0}SO_{0.10}AR coating (2.20×10⁴ Ω·cm²). This indicated that for coatings with water contact angles ranging from 125° to 140°, after immersion in a 3.5 wt % NaCl solution for 1 day, the anti-corrosion ability showed a trend of first increasing and decreasing, and the coating with a water contact angle of 130° had the optimal anti-corrosion ability, which was consistent with the trend observed in the impedance plots. After immersion in a 3.5 wt % NaCl solution for 3 days, the CK_{1.0}SO_{0.05}AR coating still had the maximum modulus value (2.70×10⁶ Ω·cm²). The modulus value of the CK_{1.0}SO₀AR coating was 2.40×10⁵ Ω·cm², which was close to that of the CK_{1.0}SO_{0.10}AR coating (1.85×10⁵ Ω·cm²), and both were higher than the modulus value of the CK_{1.0}SO_{0.17}AR coating (1.52×10⁴ Ω·cm²). The variation trend of anti-corrosion performance was consistent with that observed after 1 day of immersion. After immersion in a 3.5 wt % NaCl solution for 7 days, the CK_{1.0}SO_{0.05}AR coating exhibited the maximum modulus value, which was 1.40×10⁶ Ω·cm². The modulus value of the CK_{1.0}SO₀AR coating was 1.75×10⁵ Ω2·cm², which was close to that of the CK_{1.0}SO_{0.10}AR coating (1.45×10⁵ Ω·cm²). Both values were higher than the modulus value of the CK_{1.0}SO_{0.17}AR coating (1.14×10⁴ Ω·cm²). The variation trend of anti-corrosion performance was consistent with those observed after 1 day and 3 days of immersion, as well as with the trend derived from the electrochemical impedance spectroscopy (EIS) results.

FIG. 7A shows Bode results of hydrophobic coatings from Comparative Example 4, Comparative Example 5 and Comparative Example 6 after immersion in a 3.5 wt % NaCl solution for 1 day; FIG. 7B shows Bode results of hydrophobic coatings from Comparative Example 4, Comparative Example 5 and Comparative Example 6 after immersion in a 3.5 wt % NaCl solution for 3 days; and FIG. 7C shows Bode results of hydrophobic coatings from Comparative Example 4, Comparative Example 5 and Comparative Example 6 after immersion in a 3.5 wt % NaCl solution for 7 days.

For coatings with water contact angles ranging from 145° to 156°, after immersion in a 3.5 wt % NaCl solution for 1 day, the CK_{1.0}SO_{0.30}AR coating exhibited the maximum Bode modulus value at f=0.1 Hz, which was approximately 1.30×10⁵ Ω·cm². This value was higher than the modulus value of the CK_{1.0}SO_{0.25}AR coating (8.80×10⁴ Ω·cm²), and both were higher than the modulus value of the CK_{1.0}SO_{0.20}AR coating (8.02×10⁴ Ω·cm²). This indicated that for coatings with water contact angles ranging from 145° to 156°, after immersion in a 3.5 wt % NaCl solution for 1 day, the anti-corrosion ability showed an upward trend, which was consistent with the trend observed in the impedance plots. After immersion in a 3.5 wt % NaCl solution for 3 days, the CK_{1.0}SO_{0.30}AR coating still exhibited the maximum Bode modulus value, which was approximately 1.17×10⁵ Ω·cm². This value was higher than the modulus value of the CK_{1.0}SO_{0.25}AR coating (7.80×10⁴ Ω·cm²), and both were higher than the modulus value of the CK_{1.0}SO_{0.20}AR coating (7.42×10⁴ Ω·cm²). This was consistent with the corrosion variation trend observed after 1 day of immersion. After immersion in a 3.5 wt % NaCl solution for 7 days, the CK_{1.0}SO_{0.30}AR coating maintained the maximum Bode modulus value, which was approximately 1.01×10⁵ Ω·cm². This value was higher than the modulus value of the CK_{1.0}SO_{0.25}AR coating (6.05×10⁴ Ω2·cm²), and both were higher than the modulus value of the CK_{1.0}SO_{0.20}AR coating (3.82×10⁴ Ω·cm²). This was consistent with the corrosion variation trends observed after 1 day and 3 days of immersion, as well as with the trend derived from the impedance test results.

To further illustrate the beneficial effects of the present disclosure, the following comparative examples are also designed.

### Comparative Example 7

In this comparative example, a dosage of AR was 0.5 g, and all other conditions were kept the same as those in Example 1.

### Comparative Example 8

In this comparative example, a dosage of AR was 1 g, and all other conditions were kept the same as those in Example 1.

### Comparative Example 9

In this comparative example, a dosage of kaolin was 0.5 g, and all other conditions were kept the same as those in Example 1.

### Comparative Example 10

In this comparative example, a dosage of kaolin was 1.2 g, and all other conditions were kept the same as those in Example 1.

### Comparative Example 11

In this comparative example, the particle size of kaolin was in a range of 500-800 nm, and all the other conditions were kept the same as those in Example 1.

### Comparative Example 12

In this comparative example, the particle size of kaolin was in a range of 1-4 μm, and all the other conditions were kept the same as those in Example 1.

### Comparative Example 13

In this comparative example, the particle size of kaolin was in a range of 5-8 μm, and all the other conditions were kept the same as those in Example 1.

### Comparative Example 14

In this comparative example, the kaolin powder was a mixture of particles with particle sizes of 1-4 μm and 5-8 μm at a mass ratio of 1:1, and all the other conditions were kept the same as those in Example 1.

### Comparative Example 15

In this comparative example, the kaolin powder was a mixture of particles with particle sizes of 1-4 μm and 5-8 μm at a mass ratio of 1:3, and all the other conditions were kept the same as those in Example 1.

The performance comparison between the coatings prepared in the above comparative examples and the hydrophobic coating prepared in Example 1 was performed, and the results are presented in Tables 3-4.

TABLE 3

| Sample No. | Contact angle/° |
|---|---|
| Comparative Example 7 | 152.23 |
| Comparative Example 8 | 145.16 |
| Comparative Example 9 | 141.15 |
| Comparative Example 10 | 153.08 |
| Comparative Example 11 | 140.34 |
| Comparative Example 12 | 144.58 |
| Comparative Example 13 | 151.36 |
| Comparative Example 14 | 148.42 |
| Comparative Example 15 | 154.07 |

It can be seen from Table 3 that adjusting the dosages of AR and kaolin leads to changes in the contact angle, and adjusting the particle size and proportion of kaolin also results in variations in the contact angle.

The impedance results of the coatings prepared in Comparative Examples 7-15 after immersion in a 3.5 wt % NaCl solution for 1 day, 3 days, and 7 days are shown in Table 4.

TABLE 4

| Time | Sample | Rs | C | Rp |
|---|---|---|---|---|
| (days) | No. | (Ω · cm²) | (Ω⁻¹ · cm⁻² · sn) | (Ω · cm²) |
| 1 | Comparative | 1.47 × 10⁴ | 4.24 × 10⁻⁷ | 7.52 × 10⁴ |
| | Example 7 | | | |
| | Comparative | 1.92 × 10⁴ | 8.32 × 10⁻⁷ | 5.54 × 10⁴ |
| | Example 8 | | | |
| | Comparative | 1.74 × 10⁴ | 7.23 × 10⁻⁷ | 4.13 × 10⁴ |
| | Example 9 | | | |
| | Comparative | 1.73 × 10⁴ | 2.12 × 10⁻⁷ | 8.32 × 10⁴ |
| | Example 10 | | | |
| | Comparative | 1.98 × 10⁴ | 9.01 × 10⁻⁷ | 2.48 × 10⁴ |
| | Example 11 | | | |
| | Comparative | 1.83 × 10⁴ | 8.84 × 10⁻⁷ | 5.12 × 10⁴ |
| | Example 12 | | | |
| | Comparative | 1.86 × 10⁴ | 7.12 × 10⁻⁷ | 6.72 × 10⁴ |
| | Example 13 | | | |
| | Comparative | 1.54 × 10⁴ | 7.98 × 10⁻⁷ | 6.01 × 10⁴ |
| | Example 14 | | | |
| | Comparative | 2.13 × 10⁴ | 1.03 × 10⁻⁷ | 8.94 × 10⁴ |
| | Example 15 | | | |
| 3 | Comparative | 1.43 × 10⁴ | 2.14 × 10⁻⁷ | 7.33 × 10⁴ |
| | Example 7 | | | |
| | Comparative | 1.24 × 10⁴ | 6.84 × 10⁻⁷ | 5.21 × 10⁴ |
| | Example 8 | | | |
| | Comparative | 1.36 × 10⁴ | 8.32 × 10⁻⁷ | 3.92 × 10⁴ |
| | Example 9 | | | |
| | Comparative | 2.08 × 10⁴ | 1.96 × 10⁻⁷ | 8.19 × 10⁴ |
| | Example 10 | | | |
| | Comparative | 1.31 × 10⁴ | 1.01 × 10⁻⁶ | 2.21 × 10⁴ |
| | Example 11 | | | |
| | Comparative | 1.61 × 10⁴ | 7.64 × 10⁻⁷ | 5.09 × 10⁴ |
| | Example 12 | | | |
| | Comparative | 1.52 × 10⁴ | 2.31 × 10⁻⁷ | 6.42 × 10⁴ |
| | Example 13 | | | |
| | Comparative | 1.64 × 10⁴ | 3.18 × 10⁻⁷ | 5.87 × 10⁴ |
| | Example 14 | | | |
| | Comparative | 1.76 × 10⁴ | 1.93 × 10⁻⁷ | 8.72 × 10⁴ |
| | Example 15 | | | |
| 7 | Comparative | 1.18 × 10⁴ | 1.06 × 10⁻⁶ | 6.98 × 10⁴ |
| | Example 7 | | | |
| | Comparative | 1.64 × 10³ | 4.86 × 10⁻⁶ | 2.71 × 10⁴ |
| | Example 8 | | | |
| | Comparative | 1.43 × 10⁴ | 7.23 × 10⁻⁶ | 1.98 × 10⁴ |
| | Example 9 | | | |
| | Comparative | 1.13 × 10⁴ | 7.41 × 10⁻⁷ | 7.21 × 10⁴ |
| | Example 10 | | | |
| | Comparative | 1.36 × 10³ | 6.58 × 10⁻⁶ | 1.24 × 10⁴ |
| | Example 11 | | | |
| | Comparative | 1.56 × 10⁴ | 5.23 × 10⁻⁶ | 2.32 × 10⁴ |
| | Example 12 | | | |
| | Comparative | 1.94 × 10³ | 2.28 × 10⁻⁶ | 5.21 × 10⁴ |
| | Example 13 | | | |
| | Comparative | 1.18 × 10⁴ | 4.32 × 10⁻⁶ | 3.32 × 10⁴ |
| | Example 14 | | | |
| | Comparative | 1.20 × 10⁴ | 6.08 × 10⁻⁷ | 7.42 × 10⁴ |
| | Example 15 | | | |

It can be seen from Table 4 that reducing or increasing the dosages of acrylate and kaolin, or adjusting the particle size of kaolin, results in a decrease of two orders of magnitude in the impedance radius of the prepared anti-corrosion coatings. This phenomenon may be attributed to the fact that the increase in contact angle enables the coating to absorb air and form an air layer, which in turn leads to more pores in the coating. These pores increase the probability of contact between the corrosive medium and the substrate, thereby reducing the anti-corrosion ability of the coating and resulting in a two-order-of-magnitude decrease in the impedance radius of the prepared anti-corrosion coatings.

The present disclosure also optimizes the preparation method for the nano-silica, including the following specific examples.

### Example 2

The present disclosure provides a preparation method for a hydrophobic anti-corrosion coating, including the following steps.

In step 1: nano-silica was prepared:

(1) Absolute ethanol (50 mL) and ammonia solution (50 mL) were dispersed in a 250 mL beaker. The above mixed solution was placed under magnetic stirring and stirred for 0.5 hours until no delamination occurred in the solution.

(2) 0.6 g of silane modifier was added to the above mixed solution, and uniform mixing was achieved by stirring. The silane modifier was a mixture of dimethyldiethoxysilane, vinyltrimethoxysilane and γ-aminopropyltriethoxysilane at a mass ratio of 1:1.5:2.

(3) Under stirring conditions, 2 mL of TEOS was added dropwise to the mixed solution obtained in step (2), and continuous stirring was performed for 4 hours.

(4) 1.0 g of fluorine-containing modifier was added, and uniform mixing was achieved by stirring. The fluorine-containing modifier was a mixture of hexafluorobutyl methacrylate and 1H, 1H,2H,2H-perfluorodecyltriethoxysilane at a mass ratio of 1:0.8.

(5) Centrifugation was performed in a high-speed centrifuge at 5000 r/min for 30 minutes, and the supernatant was discarded. The solid component was subjected to suction filtration (the filter membrane used was a PVC membrane with a pore size of 0.22 μm), and a solid product was obtained. The solid product was washed three times with absolute ethanol, dried in an oven at 60° C., ground and sieved through a 5000-mesh sieve, and finally nano-silica was obtained.

In step 2:1.0 g of kaolin powder, 0.66 g of AR (SGR-7120 with a molecular weight of 13000, supplied by Guangzhou Changhao Trading Co., Ltd., formerly Guangzhou Xianghao Chemical Co., Ltd.) and 0.05 g of nano-silica were added to ethyl acetate. The mixture was ultrasonically dispersed for 30 minutes and magnetically stirred for 4 hours, followed by further magnetic stirring at room temperature, and a pre-cured mixture was obtained. The kaolin powder was a mixture of particles with sizes of 1-4 μm and 5-8 μm at a mass ratio of 1:2.5.

In step 3: the pre-cured mixed liquid was drop-coated onto the substrate, Q235 steel electrode sheet, with a drop-coating amount of 2 mL/cm². The coating was cured at room temperature for 24 hours, and a hydrophobic anti-corrosion coating was obtained.

### Example 3

In this example, the AR used was Mitsubishi (Japan) butyl rubber (BR)-113 (molecular weight: 30,000), and all other conditions were kept the same as those in Example 2.

### Example 4

In this example, the AR used was Mitsubishi (Japan) BR-116 (molecular weight: 45000), and all other conditions were kept the same as those in Example 2.

### Example 5

The present disclosure provides a preparation method for a hydrophobic anti-corrosion coating, including the following steps.

In step 1: nano-silica was prepared:

(1) Absolute ethanol (50 mL) and ammonia solution (50 mL) were dispersed in a 250 mL beaker. The above mixed solution was placed under magnetic stirring and stirred for 0.5 hours until no delamination occurred in the solution.

(2) 0.5 g of silane modifier was added to the above mixed solution, and uniform mixing was achieved by stirring. The silane modifier was a mixture of dimethyldiethoxysilane, vinyltrimethoxysilane and γ-aminopropyltriethoxysilane at a mass ratio of 1:1.5:2.

(3) Under stirring conditions, 1 mL of TEOS was added dropwise to the mixed solution obtained in step (2), and continuous stirring was performed for 2 hours. The volume ratio of the TEOS to the mixed solution obtained in step (1) was in the range of 1:50-100.

(4) 1.0 g of fluorine-containing modifier was added, and uniform mixing was achieved by stirring. The fluorine-containing modifier was a mixture of hexafluorobutyl methacrylate and 1H, 1H,2H,2H-perfluorodecyltriethoxysilane at a mass ratio of 1:0.8.

(5) Centrifugation was performed in a high-speed centrifuge at 5000 r/min for 30 minutes, and the supernatant was discarded. The solid component was subjected to suction filtration (the filter membrane employed was a PVC membrane with a pore size of 0.22 μm), and a solid product was obtained. The solid product was washed three times with absolute ethanol, dried in an oven at 60° C., ground and sieved through a 5000-mesh sieve, and finally modified nano-silica was obtained.

In step 2:1.0 g of kaolin powder, 0.66 g of AR (BR-113 with a molecular weight of 30000, supplied by Guangzhou Changhao Trading Co., Ltd., formerly Guangzhou Xianghao Chemical Co., Ltd.) and 0.05 g of modified nano-silica were added to ethyl acetate. The mixture was ultrasonically dispersed for 40 minutes and magnetically stirred for 2 hours, followed by further magnetic stirring at room temperature, and a pre-cured mixture was obtained. The kaolin powder was a mixture of particles with sizes of 1-4 μm and 5-8 μm at a mass ratio of 1:2.5.

In step 3: the pre-cured mixed liquid was drop-coated onto the substrate, Q235 steel electrode sheet, with a drop-coating amount of 1 mL/cm². The coating was cured at room temperature for 18 hours, and a hydrophobic anti-corrosion coating was obtained.

### Example 6

The present disclosure provides a preparation method for a hydrophobic anti-corrosion coating, including the following steps.

In step 1: nano-silica was prepared:

(1) Absolute ethanol (50 mL) and ammonia solution (50 mL) were dispersed in a 250 mL beaker. The above mixed solution was placed under magnetic stirring and stirred for 0.5 hours until no delamination occurred in the solution.

(2) 0.8 g of silane modifier was added to the above mixed solution, and uniform mixing was achieved by stirring. The silane modifier was a mixture of dimethyldiethoxysilane, vinyltrimethoxysilane and γ-aminopropyltriethoxysilane at a mass ratio of 1:1.5:2.

(3) Under stirring conditions, 2 mL of TEOS was added dropwise to the mixed solution obtained in step (2), and continuous stirring was performed for 2 hours. The volume ratio of the TEOS to the mixed solution obtained in step (1) was in the range of 1:50-100.

(4) 1.6 g of fluorine-containing modifier was added, and uniform mixing was achieved by stirring. The fluorine-containing modifier was a mixture of hexafluorobutyl methacrylate and 1H, 1H,2H,2H-perfluorodecyltriethoxysilane at a mass ratio of 1:0.8.

(5) Centrifugation was performed in a high-speed centrifuge at 5000 r/min for 30 minutes, and the supernatant was discarded. The solid component was subjected to suction filtration (the filter membrane employed was a PVC membrane with a pore size of 0.22 μm), and a solid product was obtained. The solid product was washed five times with absolute ethanol, dried in an oven at 60° C., ground and sieved through a 5000-mesh sieve, and finally modified nano-silica was obtained.

In step 2:1.0 g of kaolin powder, 0.66 g of AR (BR-113 with a molecular weight of 30000, supplied by Guangzhou Changhao Trading Co., Ltd., formerly Guangzhou Xianghao Chemical Co., Ltd.) and 0.05 g of modified nano-silica were added to ethyl acetate. The mixture was ultrasonically dispersed for 60 minutes and magnetically stirred for 1 hours, followed by further magnetic stirring at room temperature, and a pre-cured mixture was obtained. The kaolin powder was a mixture of particles with sizes of 1-4 μm and 5-8 μm at a mass ratio of 1:2.5.

In step 3: the pre-cured mixed liquid was drop-coated onto the substrate, Q235 steel electrode sheet, with a drop-coating amount of 0.5 mL/cm². The coating was cured at room temperature for 12 hours, and a hydrophobic anti-corrosion coating was obtained.

The hydrophobic and anti-corrosion performances of the hydrophobic anti-corrosion coatings prepared in the above examples were tested, and the results are shown in Tables 5-6.

TABLE 5

| Sample No. | Contact angle/° |
|---|---|
| Example 2 | 156.23 |
| Example 3 | 153.14 |
| Example 4 | 151.42 |
| Example 5 | 148.68 |
| Example 6 | 144.73 |

It can be seen from Table 5 that the modification of nano-silica can effectively increase its water contact angle.

The impedance results of the coatings prepared in Examples 2-6 when immersed in 3.5 wt % NaCl solution for 1 day, 3 days, and 7 days are shown in Table 6.

TABLE 6

| Time | Sample | Rs | C | Rp |
|---|---|---|---|---|
| (days) | No. | (Ω · cm²) | (Ω⁻¹ · cm⁻² · sn) | (Ω · cm²) |
| 1 | Example 2 | 2.46 × 10⁴ | 1.10 × 10⁻¹² | 9.53 × 10⁷ |
| | Example 3 | 1.46 × 10⁴ | 2.08 × 10⁻¹¹ | 8.46 × 10⁷ |
| | Example 4 | 1.24 × 10⁴ | 7.06 × 10⁻¹¹ | 6.89 × 10⁷ |
| | Example 5 | 1.68 × 10⁴ | 7.83 × 10⁻¹¹ | 6.12 × 10⁷ |
| | Example 6 | 1.19 × 10⁴ | 8.72 × 10⁻¹⁰ | 5.24 × 10⁶ |
| 3 | Example 2 | 1.63 × 10⁴ | 1.90 × 10⁻¹² | 9.01 × 10⁷ |
| | Example 3 | 1.73 × 10⁴ | 1.84 × 10⁻¹¹ | 8.23 × 10⁷ |
| | Example 4 | 1.38 × 10⁴ | 2.24 × 10⁻¹¹ | 6.56 × 10⁷ |
| | Example 5 | 1.71 × 10⁴ | 3.08 × 10⁻¹¹ | 5.92 × 10⁷ |
| | Example 6 | 1.92 × 10⁴ | 7.38 × 10⁻¹⁰ | 5.14 × 10⁶ |
| 7 | Example 2 | 1.63 × 10⁴ | 1.52 × 10⁻¹² | 8.57 × 10⁷ |
| | Example 3 | 1.41 × 10⁴ | 7.23 × 10⁻¹¹ | 7.29 × 10⁷ |
| | Example 4 | 1.58 × 10⁴ | 2.18 × 10⁻¹¹ | 5.34 × 10⁷ |
| | Example 5 | 1.66 × 10⁴ | 4.18 × 10⁻¹¹ | 3.45 × 10⁷ |
| | Example 6 | 1.67 × 10⁴ | 5.03 × 10⁻¹⁰ | 1.36 × 10⁶ |

It can be seen from Table 6 that the modification of nano-silica can improve its anti-corrosion performance on the original basis, and the impedance radius can be increased by 1-2 orders of magnitude. It is proved that the method of the present disclosure successfully prepares the anti-corrosion coating with good hydrophobic performance and excellent anti-corrosion ability.

To further illustrate the effect of the preparation of nano-silica on the coating, the following comparative examples are constructed.

### Comparative Example 16

In this comparative example, the AR used was Mitsubishi (Japan) BR-106 (molecular weight 6,0000), and all other conditions were kept the same as those in Example 2.

### Comparative Example 17

In this comparative example, the silane modifier was a mixture of vinyltrimethoxysilane and γ-aminopropyltriethoxysilane at a mass ratio of 2.5:2, and all the other conditions were kept the same as those in Example 2.

### Comparative Example 18

In this comparative example, the silane modifier mixture of dimethyldiethoxysilane, vinyltrimethoxysilane and γ-aminopropyltriethoxysilane at a mass ratio of 2.5:2, and all the other conditions were kept the same as those in Example 2.

### Comparative Example 19

In this comparative example, the silane modifier was a mixture of vinyltrimethoxy silane and γ-aminopropyltriethoxysilane at a mass ratio of 1.5:3, and all the other conditions were kept the same as those in Example 2.

### Comparative Example 20

In this comparative example, the silane modifier was a mixture of dimethyldiethoxysilane and γ-aminopropyltriethoxysilane at a mass ratio of 1:3.5, and all the other conditions were kept the same as those in Example 2.

### Comparative Example 21

In this comparative example, the silane modifier was a mixture of dimethyldiethoxysilane, vinyltrimethoxysilane and γ-aminopropyltriethoxysilane at a mass ratio of 1:1:1, and all the other conditions were kept the same as those in Example 2.

### Comparative Example 22

In this comparative example, the silane modifier was a mixture of dimethyldiethoxysilane, vinyltrimethoxysilane and γ-methacryloxypropyltrimethoxysilane at a mass ratio of 1:1:1, and all the other conditions were kept the same as those in Example 2.

### Comparative Example 23

In this comparative example, the fluorine-containing modifier was hexafluorobutyl methacrylate, and all the other conditions were kept the same as those in Example 2.

### Comparative Example 24

In this comparative example, the fluorine-containing modifier was 1H, 1H,2H,2H-perfluorodecyltriethoxysilane, and all the other conditions were kept the same as those in Example 2.

### Comparative Example 25

In this comparative example, the fluorine-containing modifier was a mixture of hexafluorobutyl methacrylate and 1H, 1H,2H,2H-perfluorodecyltriethoxysilane at a mass ratio of 1:1, and all the other conditions were kept the same as those in Example 2.

### Comparative Example 26

In this comparative example, the fluorine-containing modifier was a mixture of hexafluorobutyl methacrylate and 1H,1H,2H,2H-perfluorodecyltriethoxysilane at a mass ratio of 0.8:1, and all the other conditions were kept the same as those in Example 2.

### Comparative Example 27

In this comparative example, the fluorine-containing modifier was a mixture of hexafluorobutyl methacrylate and 1H,1H,2H,2H-perfluorodecyltriethoxysilane at a mass ratio of 1:0.5, and all the other conditions were kept the same as those in Example 2.

### Comparative Example 28

In this comparative example, the fluorine-containing modifier was a mixture of dodecafluoroheptyl methacrylate and 1H,1H,2H,2H-perfluorodecyltriethoxysilane at a mass ratio of 1:0.8, and all the other conditions were kept the same as those in Example 2.

### Comparative Example 29

The present disclosure provides a preparation method for a hydrophobic anti-corrosion coating, including the following steps.

In step 1: nano-silica was prepared and modified.

Absolute ethanol (50 mL) and ammonia solution (50 mL) were dispersed in a 250 mL beaker. The above mixed solution was placed under magnetic stirring and stirred for 0.5 hours until no delamination occurred in the solution. 2 mL of TEOS was added dropwise to the continuously stirred mixed solution; and floccules appeared in the solution, and stirring was continued for 4 hours until no more silica spheres were generated. The mixture was centrifuged at 5000 r/min for 30 minutes using a high-speed centrifuge; the supernatant was removed, and the solid was subjected to suction filtration (the filter membrane was a PVC membrane with a pore size of 0.22 μm) to remove residual absolute ethanol and ammonia solution. The solid was washed twice with ethanol, and self-prepared silica nanoparticles were obtained.

1 g of nano-SiO₂ particles were weighed out. The weighed particles were added to a flask including 50 mL of ethanol, followed by the addition of 1 mL of ammonia water. The flask was placed in an ultrasonic cleaner for ultrasonic dispersion for 30 minutes, uniform dispersion of SiO₂ was achieved, and a nano-SiO₂/ethanol suspension was obtained. Subsequently, 2 mL of octadecyltrimethoxysilane was added dropwise rapidly under stirring conditions, and a reaction was performed for 4 hours. After the completion of the modification reaction, the obtained liquid was centrifuged at a rotation speed of 5000 r for 30 minutes in a centrifuge for separation. The separated solid was washed repeatedly with ethanol twice, placed in an oven at 60° C. for drying for 12 hours, and fully ground thereafter. Finally, modified nano-SiO₂ powder was obtained.

Steps 2-3 were the same as in Example 2 to obtain an anti-corrosion coating.

### Comparative Example 30

The present disclosure provides a preparation method for a hydrophobic anti-corrosion coating, including the following steps.

In step 1: nano-silica was prepared and modified.

Absolute ethanol (50 mL) and ammonia solution (50 mL) were dispersed in a 250 mL beaker. The above mixed solution was placed under magnetic stirring and stirred for 0.5 hours until no delamination occurred in the solution. 2 mL of TEOS was added dropwise to the continuously stirred mixed solution; and floccules appeared in the solution, and stirring was continued for 4 hours until no more silica spheres were generated. The mixture was centrifuged at 5,000 r/min for 30 minutes using a high-speed centrifuge; the supernatant was removed, and the solid was subjected to suction filtration (the filter membrane was a PVC membrane with a pore size of 0.22 μm) to remove residual absolute ethanol and ammonia solution. The solid was washed twice with ethanol, and self-prepared silica nanoparticles were obtained.

1 g of nano-SiO₂ particles were weighed out. The weighed particles were added to a flask including 50 mL of ethanol, followed by the addition of 1 mL of ammonia water. The flask was placed in an ultrasonic cleaner for ultrasonic dispersion for 30 minutes, uniform dispersion of SiO₂ was achieved, and a nano-SiO₂/ethanol suspension was obtained. Subsequently, 2 mL of a mixture including dimethyldiethoxysilane, vinyltrimethoxysilane and γ-aminopropyltriethoxysilane at a mass ratio of 1:1.5:2 was added dropwise rapidly under stirring conditions, followed by a reaction that was performed for 4 hours. After the completion of the modification reaction, the obtained liquid was centrifuged at a rotation speed of 5000 r for 30 minutes in a centrifuge for separation. The separated solid was washed repeatedly with ethanol twice, placed in an oven at 60° C. for drying for 12 hours, and fully ground thereafter. Finally, modified nano-SiO₂ powder was obtained.

Steps 2-3 were the same as in Example 2 to obtain an anti-corrosion coating.

The performance comparison between the coatings prepared in the above comparative examples and the hydrophobic coating prepared in Example 2 was performed, and the results are presented in Tables 7-10.

TABLE 7

| Sample No. | Contact angle/° |
|---|---|
| Comparative Example 16 | 152.36 |
| Comparative Example 17 | 151.56 |
| Comparative Example 18 | 152.13 |
| Comparative Example 19 | 150.96 |
| Comparative Example 20 | 150.23 |
| Comparative Example 21 | 154.48 |
| Comparative Example 22 | 149.34 |
| Comparative Example 23 | 148.12 |
| Comparative Example 24 | 155.33 |
| Comparative Example 25 | 153.21 |
| Comparative Example 26 | 154.12 |
| Comparative Example 27 | 151.63 |
| Comparative Example 28 | 152.45 |
| Comparative Example 29 | 150.32 |
| Comparative Example 30 | 154.24 |

It can be seen from Table 7 that adjusting the molecular weight of AR, as well as the dosages of silane modifier and fluorine-containing modifier, exerts little influence on the hydrophobic performances of the prepared anti-corrosion coatings.

The impedance results of the coatings prepared in Comparative Examples 16-30 after immersion in a 3.5 wt % NaCl solution for 1 day are shown in Table 8.

TABLE 8

| Sample No. | Rs (Ω · cm²) | C (Ω⁻¹ · cm⁻² · sn) | Rp (Ω · cm²) |
|---|---|---|---|
| Comparative | 1.39 × 10⁴ | 4.19 × 10⁻⁹ | 3.64 × 10⁶ |
| Example 16 | | | |
| Comparative | 1.45 × 10⁴ | 6.59 × 10⁻⁹ | 2.82 × 10⁶ |
| Example 17 | | | |
| Comparative | 1.24 × 10⁴ | 4.38 × 10⁻⁹ | 3.46 × 10⁶ |
| Example 18 | | | |
| Comparative | 1.71 × 10⁴ | 7.19 × 10⁻⁹ | 2.58 × 10⁶ |
| Example 19 | | | |
| Comparative | 1.79 × 10⁴ | 7.63 × 10⁻⁹ | 2.34 × 10⁶ |
| Example 20 | | | |
| Comparative | 1.63 × 10⁴ | 1.01 × 10⁻⁹ | 5.63 × 10⁶ |
| Example 21 | | | |
| Comparative | 1.26 × 10⁴ | 8.13 × 10⁻⁹ | 2.18 × 10⁶ |
| Example 22 | | | |
| Comparative | 1.96 × 10⁴ | 8.53 × 10⁻⁹ | 1.83 × 10⁶ |
| Example 23 | | | |
| Comparative | 1.52 × 10⁴ | 9.87 × 10⁻¹⁰ | 5.84 × 10⁶ |
| Example 24 | | | |
| Comparative | 1.31 × 10⁴ | 1.45 × 10⁻⁹ | 4.64 × 10⁶ |
| Example 25 | | | |
| Comparative | 1.89 × 10⁴ | 1.05 × 10⁻⁹ | 5.21 × 10⁶ |
| Example 26 | | | |
| Comparative | 1.15 × 10⁴ | 6.38 × 10⁻⁹ | 2.94 × 10⁶ |
| Example 27 | | | |
| Comparative | 1.46 × 10⁴ | 5.73 × 10⁻⁹ | 3.12 × 10⁶ |
| Example 28 | | | |
| Comparative | 1.85 × 10⁴ | 7.32 × 10⁻⁹ | 3.14 × 10⁶ |
| Example 29 | | | |
| Comparative | 1.67 × 10⁴ | 8.14 × 10⁻⁹ | 2.33 × 10⁶ |
| Example 30 | | | |

The impedance results of the coatings prepared in Comparative Examples 16-30 after immersion in a 3.5 wt % NaCl solution for 3 days are shown in Table 9.

TABLE 9

| Sample No. | Rs (Ω · cm²) | C (Ω⁻¹ · cm⁻² · sn) | Rp (Ω · cm²) |
|---|---|---|---|
| Comparative | 1.31 × 10⁴ | 4.83 × 10⁻⁸ | 7.52 × 10⁵ |
| Example 16 | | | |
| Comparative | 1.25 × 10⁴ | 6.73 × 10⁻⁸ | 6.51 × 10⁵ |
| Example 17 | | | |
| Comparative | 1.64 × 10⁴ | 4.96 × 10⁻⁸ | 7.28 × 10⁵ |
| Example 18 | | | |
| Comparative | 1.81 × 10⁴ | 7.34 × 10⁻⁸ | 6.23 × 10⁵ |
| Example 19 | | | |
| Comparative | 1.59 × 10⁴ | 7.84 × 10⁻⁸ | 6.05 × 10⁵ |
| Example 20 | | | |
| Comparative | 1.23 × 10⁴ | 2.46 × 10⁻⁸ | 8.75 × 10⁵ |
| Example 21 | | | |
| Comparative | 1.46 × 10⁴ | 8.47 × 10⁻⁸ | 5.97 × 10⁵ |
| Example 22 | | | |
| Comparative | 1.66 × 10⁴ | 8.96 × 10⁻⁸ | 5.73 × 10⁵ |
| Example 23 | | | |
| Comparative | 1.42 × 10⁴ | 2.17 × 10⁻⁸ | 8.78 × 10⁵ |
| Example 24 | | | |
| Comparative | 1.61 × 10⁴ | 3.45 × 10⁻⁸ | 8.32 × 10⁵ |
| Example 25 | | | |
| Comparative | 1.19 × 10⁴ | 2.64 × 10⁻⁸ | 8.73 × 10⁵ |
| Example 26 | | | |
| Comparative | 1.05 × 10⁴ | 6.54 × 10⁻⁸ | 6.62 × 10⁵ |
| Example 27 | | | |
| Comparative | 1.02 × 10⁴ | 7.12 × 10⁻⁸ | 6.88 × 10⁵ |
| Example 28 | | | |
| Comparative | 1.62 × 10⁴ | 9.38 × 10⁻⁸ | 7.92 × 10⁵ |
| Example 29 | | | |
| Comparative | 1.59 × 10⁴ | 9.16 × 10⁻⁸ | 7.18 × 10⁵ |
| Example 30 | | | |

The impedance results of the coatings prepared in Comparative Examples 16-30 after immersion in a 3.5 wt % NaCl solution for 7 days are shown in Table 9.

TABLE 10

| Sample No. | Rs (Ω · cm²) | C (Ω⁻¹ · cm⁻² · sn) | Rp (Ω · cm²) |
|---|---|---|---|
| Comparative | 1.24 × 10⁴ | 7.46 × 10⁻⁷ | 5.05 × 10⁵ |
| Example 16 | | | |
| Comparative | 1.17 × 10⁴ | 9.86 × 10⁻⁷ | 3.63 × 10⁵ |
| Example 17 | | | |
| Comparative | 1.23 × 10⁴ | 7.96 × 10⁻⁷ | 4.95 × 10⁵ |
| Example 18 | | | |
| Comparative | 1.32 × 10⁴ | 9.36 × 10⁻⁷ | 2.89 × 10⁵ |
| Example 19 | | | |
| Comparative | 1.27 × 10⁴ | 9.84 × 10⁻⁷ | 2.63 × 10⁵ |
| Example 20 | | | |
| Comparative | 1.15 × 10⁴ | 5.56 × 10⁻⁷ | 5.51 × 10⁵ |
| Example 21 | | | |
| Comparative | 1.63 × 10⁴ | 1.07 × 10⁻⁷ | 2.17 × 10⁵ |
| Example 22 | | | |
| Comparative | 1.59 × 10⁴ | 1.26 × 10⁻⁷ | 1.24 × 10⁵ |
| Example 23 | | | |
| Comparative | 1.29 × 10⁴ | 5.46 × 10⁻⁷ | 5.53 × 10⁵ |
| Example 24 | | | |
| Comparative | 1.38 × 10⁴ | 6.35 × 10⁻⁷ | 5.32 × 10⁵ |
| Example 25 | | | |
| Comparative | 1.72 × 10⁴ | 5.64 × 10⁻⁷ | 5.45 × 10⁵ |
| Example 26 | | | |
| Comparative | 1.56 × 10⁴ | 9.54 × 10⁻⁷ | 3.89 × 10⁵ |
| Example 27 | | | |
| Comparative | 1.23 × 10⁴ | 8.62 × 10⁻⁷ | 2.88 × 10⁵ |
| Example 28 | | | |
| Comparative | 1.38 × 10⁴ | 8.15 × 10⁻⁷ | 6.14 × 10⁵ |
| Example 29 | | | |
| Comparative | 1.25 × 10⁴ | 9.20 × 10⁻⁷ | 5.97 × 10⁵ |
| Example 30 | | | |

It can be seen from Tables 8-10 that when the molecular weight of the AR was relatively high (as in Comparative Example 16), the impedance radius of the prepared anti-corrosion coating was reduced by 1 to 2 orders of magnitude compared with that of Example 2. This phenomenon may be attributed to the fact that the AR with a higher molecular weight has more voids and microcracks, which increases the probability of the corrosive substances contacting the substrate, thereby reducing the impedance radius of the coating.

When the components and proportions of the silane modifier and fluorine-containing modifier were adjusted (as in Comparative Examples 17-28), it was found that the impedance radius of the prepared anti-corrosion coatings was reduced by 1-2 orders of magnitude compared with that of Example 2. This phenomenon may be attributed to the fact that different silane modifiers and fluorine-containing modifiers exhibit varying capabilities in modifying silica, and different components and proportions result in distinct modification effects on the modified silica. The addition of modifiers may alter the modification effect of modified silica, thereby leading to a significant reduction in anti-corrosion ability.

On the basis of the modification of nano-silica in Example 2, the contents of AR and kaolin, as well as the particle size of kaolin, were adjusted. The impedance radius of the prepared anti-corrosion coatings was reduced by 2 to 4 orders of magnitude compared with that in Example 2, demonstrating a significant decrease in anti-corrosion ability.

The corrosion conditions of the prepared hydrophobic anti-corrosion coatings in simulated marine environments were detected to evaluate the anti-corrosion ability. Bare Q235 steel electrode sheets, as well as coatings prepared in Examples 1-6 and Comparative Examples 1-30, were immersed in 50 mL of 3.5 wt % NaCl solution under ambient temperature and atmospheric pressure for accelerated corrosion tests, and changes in surface morphology were recorded. At the initial stage of 1-day immersion, obvious changes were observed on the surface of bare electrodes with passive films formed. Coatings prepared in Examples and Comparative Examples were verified to exert certain anti-corrosion effects on substrates. However, after 1 week of immersion, blisters appeared at the edges of coatings in Comparative Examples 1-15, with cracks and rust spots formed on the exposed parts. With the extension of immersion time, rust stains gradually spread to the centers, and even coatings in Comparative Examples 1-15 peeled off from the substrates after 2 weeks, indicating that substrates lost protective layers and thus yellow porous Fe₂O₃ corrosion products were generated. After 2 weeks of immersion, slight blisters also appeared at the edges of coatings in Example 1 and Comparative Examples 16-30. After 1 month of immersion, cracks and rust spots formed on the exposed parts of coatings in Example 1 and Comparative Examples 16-30, accompanied by partial peeling-off. In contrast, coating samples prepared in Examples 2-6 still maintained stable performance after 1 month of immersion, without obvious rust spots or peeling-off observed. This phenomenon was consistent with the results of electrochemical tests. The phenomenon was attributed to the excellent dispersion of modified nano-silica in AR with specific molecular weight through the synergistic effect with kaolin of specific particle size. The synergistic effect of the three components filled the voids on the coating surface, thereby blocking more corrosive media outside the coating surface. These characteristics improved the barrier property and anti-corrosion performance of the coatings.

In the present disclosure, on the basis of the modification of nano-silica, the dosages of kaolin and AR as well as the particle size of kaolin are adjusted. The prepared coatings are found to exhibit a certain anti-corrosion effect, but the impedance radius is reduced by 2-3 orders of magnitude compared with that in Example 2, which proves that the anti-corrosion ability is deteriorated.

In summary, in the present disclosure, kaolin and AR are selected for film preparation. Kaolin with a specific particle size can reduce the pores of the film as much as possible, the added modified nano-silica further fills the pores, and the prepared coatings are endowed with better hydrophobic and anti-corrosion effects.

The above descriptions are preferred embodiments of the present disclosure. For those ordinary skilled in the art, several improvements and modifications made without departing from the principles of the present disclosure shall also be regarded as the protection scope of the present disclosure.

1. A preparation method for a hydrophobic anti-corrosion coating, comprising the steps of:
step 1: preparing nano-silica;
step 2: adding kaolin powder, acrylic resin (AR) and nano-silica into ethyl acetate, and performing magnetic stirring on the mixture at room temperature after ultrasonic dispersion to obtain a pre-cured mixed liquid, a mass ratio of the kaolin powder, the acrylic acid resin and the nano-silica being 1:0.66:0.05, the kaolin powder being a mixture of powders with particle sizes of 1-4 μm and 5-8 μm at a mass ratio of 1:2.5; and a molecular weight of the acrylic acid resin being 10000-50000; and
step 3: coating the pre-cured mixed liquid droplets on a substrate, followed by solidifying to obtain a hydrophobic anti-corrosion coating.

2. The preparation method for a hydrophobic anti-corrosion coating according to claim 1, wherein a volume-to-mass ratio of ethyl acetate to AR is 5:1.

3. The preparation method for a hydrophobic anti-corrosion coating according to claim 2, wherein in step 2, ultrasonic dispersion is performed for 30-60 minutes, and magnetic stirring is performed for 1-4 hours.

4. The preparation method for a hydrophobic anti-corrosion coating according to claim 3, wherein in step 3, the substrate is a Q235 steel electrode sheet or a glass sheet; and a drop-coating amount of the pre-cured mixture is 0.5-2 mL/cm².

5. The preparation method for a hydrophobic anti-corrosion coating according to claim 4, wherein in step 3, the curing is performed at room temperature for 12-24 hours.

6. The preparation method for a hydrophobic anti-corrosion coating according to claim 1, wherein a preparation method for the nano-silica comprises the steps of: dispersing absolute ethanol solution and ammonia water at a volume ratio of 1:1 in a beaker, and placing the above solution under magnetic stirring for 0.5 hours; adding 2 mL of tetraethyl orthosilicate (TEOS) dropwise to a continuously stirred mixed solution and stirring continuously for 4 hours; and centrifuging at 5000 r/min for 30 minutes, removing a supernatant, performing suction filtration on a solid, and washing the solid with ethanol 2-5 times to obtain the nano-silica.

7. The preparation method for a hydrophobic anti-corrosion coating according to claim 1, wherein the preparation method for the nano-silica comprises the steps of:
(1) mixing absolute ethanol solution and ammonia water, followed by stirring evenly to obtain a mixed solution;
a volume ratio of the ethanol solution to ammonia water being 1:1, a volume fraction of ethanol in the ethanol solution being 90%; and a mass fraction of NH₃·H₂O in the ammonia water being 25% to 28%;
(2) adding a silane modifier to the above mixed solution, followed by stirring uniformly;
the silane modifier being a mixture of dimethyldiethoxysilane, vinyltrimethoxysilane and γ-aminopropyltriethoxysilane at a mass ratio of 1:1.5:2; and a mass-to-volume ratio of the silane modifier to the mixed solution in step (1) being 0.5-0.8 g: 100 mL;
(3) adding TEOS dropwise to the mixed solution of step (2) under stirring conditions, followed by stirring continuously for 2-6 hours, and a volume ratio of TEOS to the mixed solution in step (1) being 1:50-100;
(4) adding a fluorine-containing modifier, followed by stirring uniformly, the fluorine-containing modifier being a mixture of hexafluorobutyl methacrylate and 1H, 1H,2H,2H-perfluorodecyltriethoxysilane at a mass ratio of 1:0.8; and a mass ratio of the fluorine-containing modifier to the silane modifier being 1:0.4-0.6; and
(5) performing centrifugal separation to obtain a solid product, washing the solid product with absolute ethanol 2-5 times, followed by drying, and grinding and sieving the solid to obtain the nano-silica.

8. An anti-corrosion coating prepared by the method according to claim 1.

9. An anti-corrosion coating prepared by the method according to claim 2.

10. An anti-corrosion coating prepared by the method according to claim 3.

11. An anti-corrosion coating prepared by the method according to claim 4.

12. An anti-corrosion coating prepared by the method according to claim 5.

13. An anti-corrosion coating prepared by the method according to claim 6.

14. An anti-corrosion coating prepared by the method according to claim 7.
